(19) United States
(12) Patent Application Publication
(10) Pub. No.: US 2009/0313138 A1
(43) Pub. Date: Dec. 17, 2009

(54) Method, System and Apparatus for Display of Contact Information on Communication Device

(75) Inventor: Nitesh Ratnakar, Elkins, WV (US)

Correspondence Address: NITESH RATNAKAR, ROUTE 3,, BOX 179-A, ELKINS, WV, 26241, US

(73) Assignee: NOVATION SCIENCE HOLDING, LLC, Elkins, WV (US)

(21) Appl. No.: 12/464,097

(22) Filed: May 11, 2009

Related U.S. Application Data
(63) Continuation-in-part of application No. 12/140,684, filed on Jun. 17, 2008.

(51) Int. Cl. G06Q 30/00; G01S 5/00

(52) U.S. Cl. 705/27; 342/357.09

(57) ABSTRACT

Present invention discloses a method, system, and apparatus for display of contact information on communication device. It comprises of first product database containing seller information, seller product information, and product location; second product database containing buyer product request; first application in mobile device having means to determine mobile device location at pre determined intervals and having means to automatically communicate mobile device location to second application; second application having means to match first and second product databases and mobile device location at pre determined intervals events to generate local matching products database; mobile device having display means for products contained in local matching product database; and mobile device having means to display contact information of sellers and buyers.

### BACKGROUND

It is a common practice to sell products on the internet using electronic devices such as personal computers and mobile devices. Buyers usually prefer to buy products in close proximity to their location. It makes for delivery of products fast, reliable, and cost effective. It also enables buyer to personally inspect and pick up products at their own convenience. Currently, web sites require input of postal code into web site search engine; where after products are displayed according to their proximity to input postal code. This is a useful method to search for local products when immobile devices, such as personal computer is used. However, with the convergence of internet with mobile devices, such as mobile phones, it is often impractical for user to remember postal code for frequently changing location of mobile device. There remains a need for technology to enable users search for products in proximity to current location of their mobile device. The convergence of GPS chipset, internet, and mobile devices present an opportunity to provide buyers with an application that will enable users to be automatically alerted of products in vicinity of current location of mobile device that match products users wish to buy without requiring manual location input.

### SUMMARY

Present invention discloses a method of product search comprising of first product database containing seller information, seller product information, and product location; second product database containing buyer product request and buyer information; first application in mobile device having means to determine mobile device location at pre determined intervals or pre defined events and having means to automatically communicate mobile device location to second application; second application having means to match first and second product databases and mobile device location at pre determined intervals/ events; and generate local matching products database; mobile device having display means for products contained in local matching product database. According to another aspect of the invention, a method to inform sellers of potential buyers in proximity of seller location is disclosed. According to yet another aspect of the invention, a method to display seller and buyer contact information on buyer and seller communication device respectively is disclosed.

### BRIEF DESCRIPTION OF DRAWINGS

FIG. 1 shows the structure of seller product database.

FIG. 1B shows structure of mobile client product database.

FIG. 1C shows product database input into central server using mobile communication devices such as mobile phone and fixed location devices such as personal computer.

FIG. 2 shows central server containing seller product database and mobile client product database.

FIG. 3 shows mobile device in communication with GPS satellite; mobile device transmitting mobile device location GPS coordinates to central server; central server containing seller product database, mobile client product database, and mobile device location GPS coordinates.

FIG. 4 shows a method, means, and apparatus for finding local products comprising of central server with artificial intelligent matching application to match seller product database, mobile client product database, and mobile device location GPS coordinates to generate a local matching product database; and having means to transmit local matching product database to corresponding mobile device.

FIG. 5 shows a method, means, and apparatus for finding local products comprising of central server containing seller product database; central server having means to transmit seller product database to one or more mobile devices; mobile device containing mobile client product database; mobile device having means to receive seller product database from central server; mobile device in communication with GPS satellite; mobile device having artificial intelligent matching application to match seller product database, mobile client product database, and mobile device location GPS co-ordinates to generate local matching product database.

FIG. 6 illustrates identical structure of seller product database in central server and seller product database in mobile device for method of local product search shown in FIG. 5.

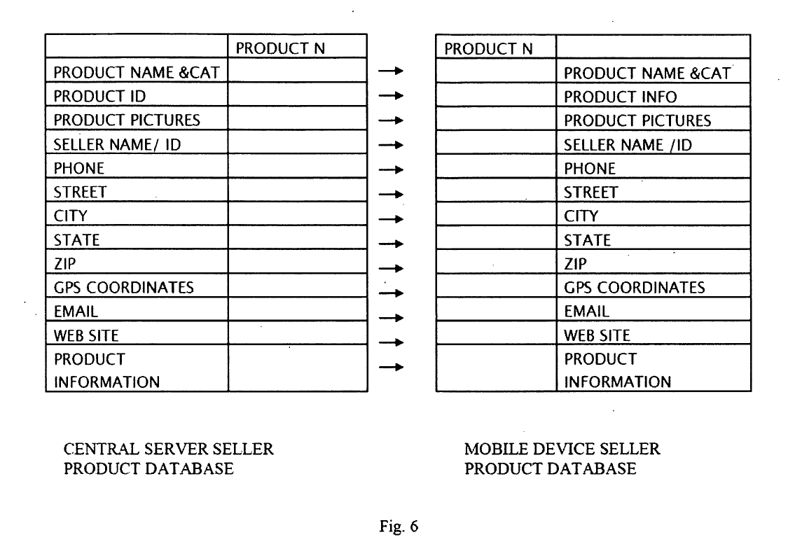

FIG. 7 shows a method, means, and apparatus for finding local products comprising of mobile device having mobile client product database; mobile device in communication with GPS satellite; mobile device in communication link with central server; mobile device having means to transmit mobile client product database and mobile device location GPS coordinates to central server; central server having seller product database; central server having means to receive mobile client product database and mobile device location GPS coordinates; central server having artificial intelligent matching application to match seller product database, mobile client product database and mobile device location GPS coordinates to generate local matching product database; central server having means to transmit local matching product database to corresponding mobile device.

FIG. 8 shows a method, means, and apparatus for finding local products comprising of central server containing seller product database and mobile client product database; central server having artificial intelligent matching application to match seller product database with mobile client product database to generate matching product database; central server having means to transmit matching product database to corresponding mobile device; mobile device in communication link with GPS satellite to obtain current location GPS co-ordinates; mobile device having matching application to match matching product database and mobile device location GPS coordinates to generate local matching product database.

FIG. 9 is an illustration of artificial intelligent matching algorithm having means to match seller product database, mobile client product database; and mobile device location GPS co-ordinates according to seller product location GPS coordinates; to generate local matching products database.

FIG. 10 shows a method to determine geographic range for location based product search.

FIG. 11 shows a method, means, and apparatus for notifying sellers of mobile clients in proximity to seller location who are looking for seller products.

FIG. 12 shows the first method, means and apparatus for display of seller contact information on mobile client device.

FIG. 13 shows the second method, means and apparatus for display of seller contact information on mobile client device.

FIG. 14 shows the third method, means and apparatus for display of seller contact information on mobile client device.

FIG. 15 shows the fourth method, means and apparatus for display of seller contact information on mobile client device.

FIG. 16 shows the first method, means and apparatus for display of buyer contact information on seller communication device.

FIG. 17 shows the second method, means and apparatus for display of buyer contact information on seller communication device.

FIG. 18 shows the third method, means and apparatus for display of buyer contact information on seller communication device.

### DETAILED DESCRIPTION OF DRAWINGS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out one or several purposes of the present invention. It is important, therefore, that the claims be regarded as including such equivalent constructions insofar as they do not depart from the spirit and scope of the present invention.

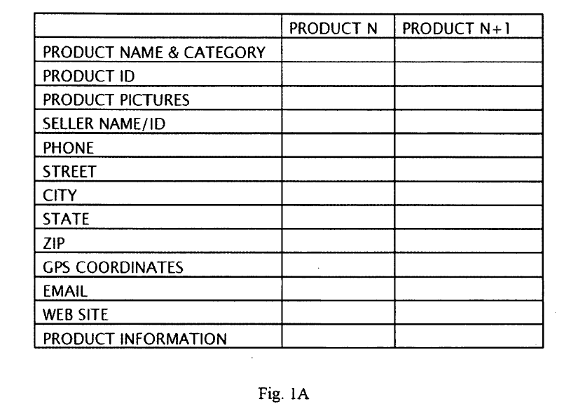

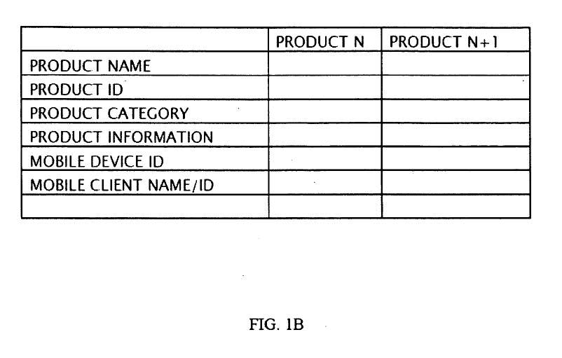

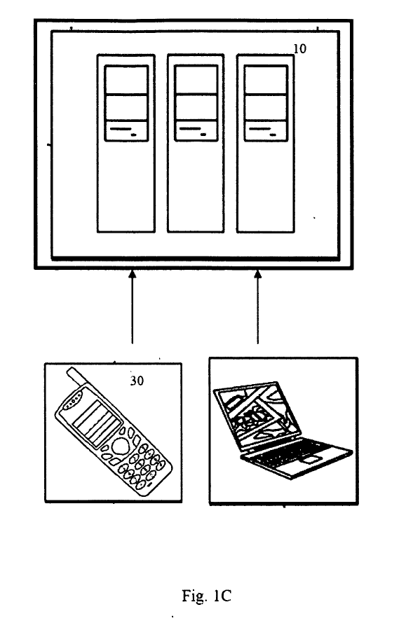

Product database comprises of seller and mobile client product databases. FIG. 1A shows seller product database structure containing data fields to capture product information and includes product name, product ID, product category, product image, seller information like seller name/ID, phone, web site, email, physical address of product location. GPS coordinates corresponding to physical location of product, and detail product information. Preferably, GPS coordinates corresponding to physical location of product is obtained from geo code database. Additionally product location can also be determined by postal code, physical address of location of product, triangulation of cellular towers and available access points corresponding to physical location of product. Seller product information can be in one or more of text, voice, image, and video formats. Mobile client product database structure, shown in FIG. 1B, contains data fields for product name, product ID, product category, detail product information, mobile device ID, and mobile client name/ID. Product information in mobile client product database can be in one or more of text, voice, image, and video formats. Mobile client product database in essence contains information about product that one or more mobile clients would like to purchase in close proximity to their location. One of many existing mobile database programs may be used for seller and mobile client product databases. Currently in the field of mobile database, Sybase Inc.'s SQL Anywhere dominates the field, with about 68% of the total mobile database market. IBM's DB2 Everyplace is a relational database and enterprise synchronization server that extends enterprise applications to mobile devices. Microsoft SQL Server Compact and Oracle9i Lite are similar mobile databases. Products from lesser-known vendors, such as SQLBase from Gupta Technologies, LLC of Redwood Shores, Calif., and HanDBase from DDH Software Inc. of Lake Worth, Fla. may also suffice. Type of database used should not be considered limiting aspect of the invention. Preferably, means is provided for data input into seller product database and mobile client product database via a web interface using fixed location devices such as personal computer or mobile devices such as mobile phones. There is a representative entity in the central server/mobile device application for each seller, mobile client (buyer) and a GIS (Geographical Information Service) where all related information is stored. Product information uploaded into seller product database is entered into corresponding seller account. Similarly, product information uploaded into mobile client product database is entered into corresponding mobile client account. Once a product request is entered into mobile client database in central server; the second application of the present invention automatically attempts to find a matching product in the seller product database based on current location of mobile device at predetermined intervals; without requiring data input into mobile client product database by mobile client each time said search application is activated. Multiple search sessions are performed by second application based on varied mobile device locations based on single input into the mobile client product database; said input coming either from fixed location devices such as personal computer or from mobile devices; as shown in FIG. 1C.

Invention comprises of central server and mobile device applications containing built in artificial intelligent algorithms to help both sellers and buyers in product's negotiations. Mobile device application and central server application may be written in one or more mobile operating systems like Java ME, Windows Mobile, Brew, Symbian, Apple OS, Android etc.

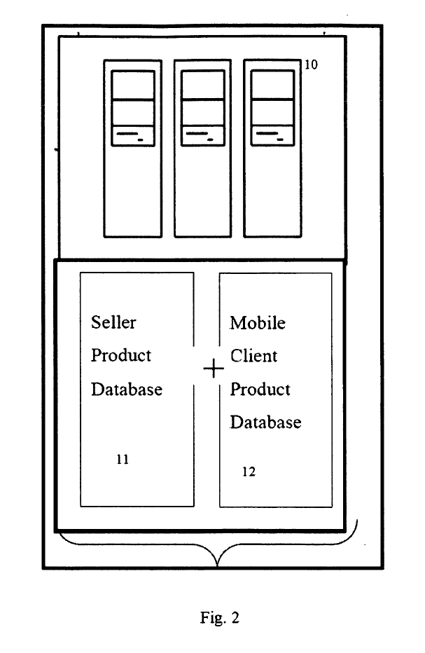

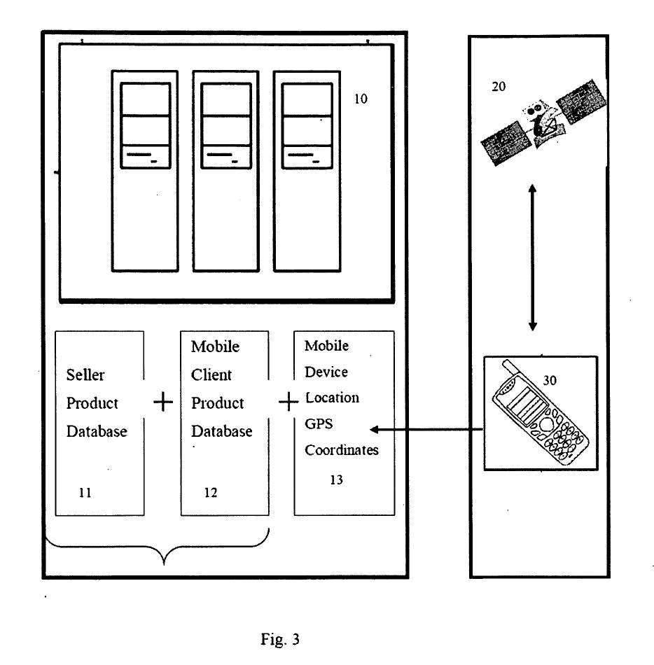

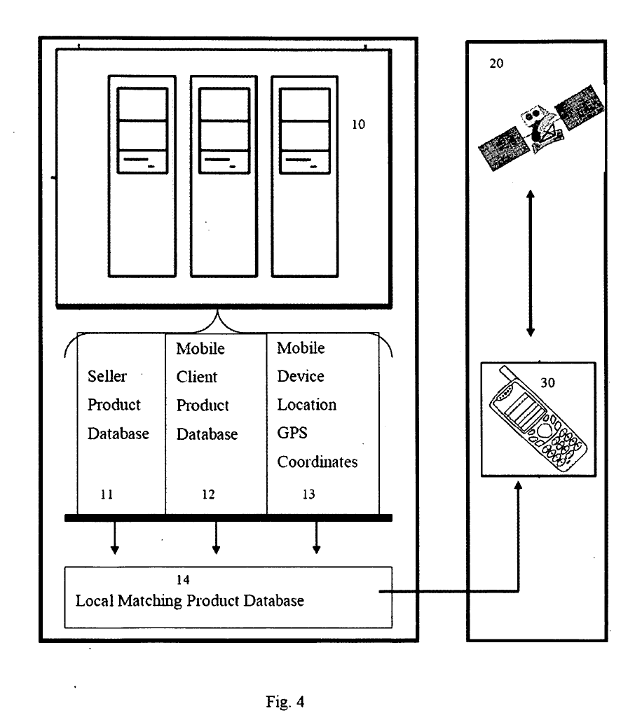

According to one method, as shown in FIGS. 2, 3 & 4, a first application in mobile device (30) having means to receive satellite (20) position from the GPS system (GPS component module) and establish communication with the central server (Communication Component module) is provided. GPS component module is preferably programmed to obtain satellite position (20), as shown in FIGS. 3 &4, at pre determined intervals. This can be achieved by operatively connecting the GPS component module to a programmable timer device. Alternatively, GPS component module can be programmed to receive uninterrupted satellite position (20) while mobile device (30) is powered on; or can be programmed to receive satellite position (20) on an on demand basis. The communication component module is programmed to ping central server (10) with mobile device GPS coordinates, as shown in FIGS. 3, at pre determined intervals. Alternatively, communication component module is programmed to communicate with central server (10) on continuous basis or on an on demand basis. A second application is provided in central server (10) containing artificial intelligent matching algorithm having means to match mobile client product database (12), seller product database (11), and mobile device location GPS coordinates (13) according to product location GPS coordinates in seller product database; and generate local matching product database (14), as shown in FIG. 4. Matching algorithm attempts to find products in seller product database that match mobile client product request in order of proximity to mobile device location. Thereafter, local matching product database (14) is transmitted from central server (10) to corresponding mobile device (30). Means is provided in mobile device application to display information and location of products contained in local matching product database (14). Preferably matching algorithm is automatically activated upon receipt of new mobile device GPS coordinates or upon entry of new products in seller/buyer product database. Preferably products contained in the local matching product database are displayed in order of their proximity to the mobile device. Means to display products in order of proximity to a communication device according to the GPS coordinates corresponding to product location in well known in the art; and does not merit detail description here. Additionally, products contained in local matching product database can also be displayed according to other hierarchical determinants such as price, product relevancy, date of posting of products etc. The invention enables mobile device to be on the look out for products contained in previously entered and saved mobile client product database in central server in proximity to mobile device location; and notify mobile client of matching products on corresponding mobile device when a matching product is found within pre determined distance of mobile device. Once a product request is entered into mobile client database; either from a fixed location device such as personal computer or mobile device; the second application automatically attempts to find a matching product in the seller product database based on current location of mobile device at predetermined intervals; without requiring mobile client input into mobile client product database each time said search application is activated. Multiple search sessions are performed by second application based on varied mobile device locations based on product request saved in mobile client product database from prior data input by mobile client; either from corresponding mobile device or separate communication device such as personal computer. As an alternative to transmitting local matching product database; second application is programmed to transmit a web link corresponding to one or more products in the local matching products database to mobile device.

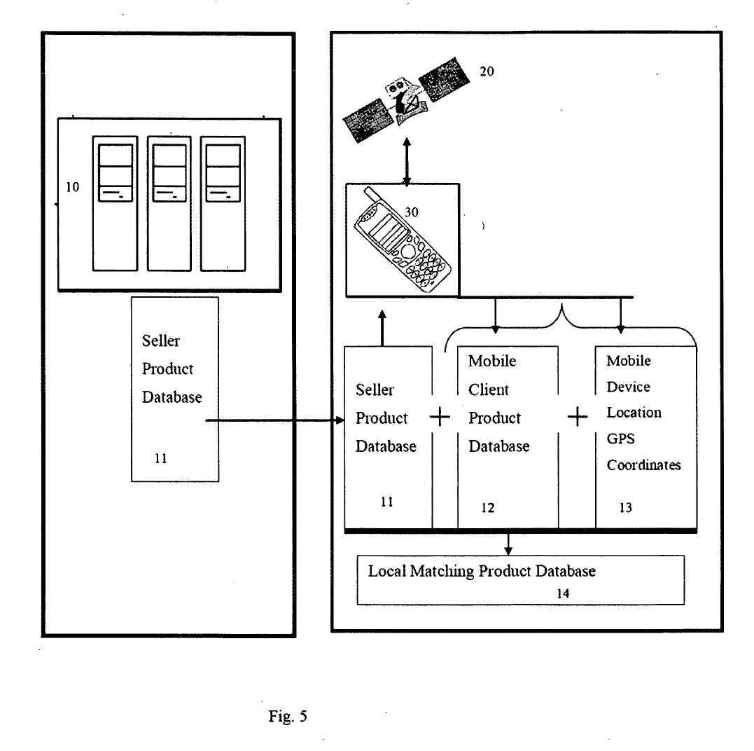

According to another method of the invention, shown in FIGS. 5 & 6, seller product database (11) is provided in central server (10) with means for seller to enter product information into seller product database (11) preferably via web interface using a fixed location device such as personal computer or a mobile device. As shown in FIGS. 5 & 6, means is provided for mobile client to download seller product database (11) from central server (10) into mobile device (30); either at predetermined intervals or when user initiated. The database structure of seller product database (11) contains matching data fields in central server (10) and mobile device (30). Alternatively, seller product data can be entered directly into seller product database (11) housed in mobile device. Mobile client product database (12) is provided in mobile device (30) with means for mobile client to enter product information into corresponding mobile device; either via mobile device interface or via download of mobile client product database from central server; said mobile client product database entered into the central server from fixed location communication devices such as personal computers or mobile devices via web interface. A first application in mobile device (30) having means to receive satellite (20) position from the GPS system (GPS component module) is provided. GPS component module is preferably programmed to obtain satellite position (20) at pre determined intervals, upon user initiation, or continuously while mobile device is powered on. A second application, also provided in mobile device (30) containing artificial intelligent matching algorithm having means to match mobile client product database (12), seller product database (11), and mobile device location GPS coordinates (13) according to product location GPS coordinates in seller product database (11); and generate local matching product database (14), as shown in FIG. 5. Preferably matching algorithm is automatically activated upon receipt of new mobile device GPS coordinates or upon entry of new products in seller/buyer product database. Matching algorithm attempts to find products in seller product database (11) that match requests in mobile client product database (12) in order of proximity to mobile device location, as shown in FIG. 5. Means is provided in mobile device (30) to display product information and product location contained in local matching product database (14). Preferably products contained in the local matching product database are displayed in order of their proximity to the mobile device. Means to display products in order of proximity to a communication device according to the GPS coordinates corresponding to product location in well known in the art; and does not merit detail description here. Additionally, products contained in local matching product database can also be displayed according to other hierarchical determinants such as price, product relevancy, date of posting of products etc. In essence, the invention enables mobile device (30) to be on the look out for product matching requests in mobile client product database in proximity of mobile device at pre determined intervals; and notify mobile client of product finding on corresponding mobile device when a matching product is found within pre determined distance of mobile device. Once a product request is entered into mobile client database; either from a fixed location device such as personal computer, corresponding mobile device interface; or from separate mobile device via web interface; the second application automatically attempts to find a matching product in the seller product database based on current location of mobile device at predetermined intervals/events; without requiring mobile client input into mobile client product database each time said search application is activated. Multiple search sessions are performed by second application based on varied mobile device locations based on product request saved in mobile client product database from prior data input by mobile client; either from a fixed location device such as personal computer, corresponding mobile device interface; or from separate mobile device via web interface.

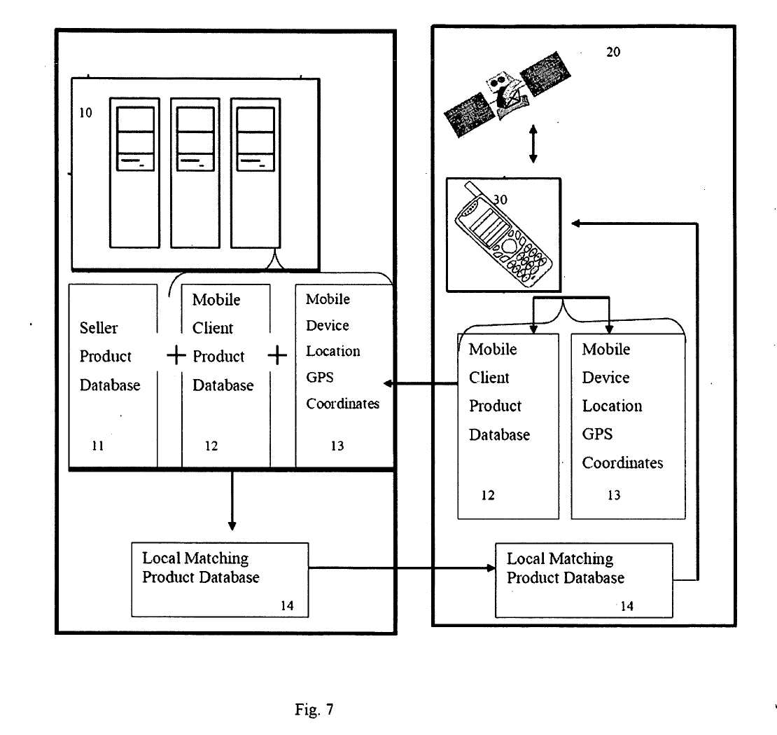

According to another method, shown in FIG. 7, mobile client product database (12) is provided in mobile device (30). Means is provided for mobile client to enter product request into mobile client product database (12) stored in mobile device; preferably via corresponding mobile device interface; or alternatively via upload from fixed location devices such as personal computer, web server, or other mobile devices. A first application in mobile device (30) having means to receive satellite (20) position from the GPS system (GPS component module) is provided. GPS component module is preferably programmed to obtain satellite position (20) at pre determined intervals, or alternatively upon user initiation, or continuously while mobile device is powered on. Means is provided in mobile device application to transmit mobile client product database (12) and mobile device GPS coordinates to central sever at predetermined intervals; or alternatively upon user initiation, upon data input, or continuously while mobile device is powered on. Seller product database (11) is provided in central server (10) with means for seller to enter product information, preferably via web interface using fixed communication devices such as personal computer or using mobile devices. A second application is provided in central server (10) containing artificial intelligent matching algorithm having means to match mobile client product database (12), seller product database (11), and mobile device location GPS coordinates (13) according to product location GPS coordinates in seller product database; and generate local matching product database (14), as shown in FIG. 7. Matching algorithm attempts to find products in seller product database that match mobile client product request in order of proximity to mobile device location. Thereafter, local matching product database (14) is transmitted from central server (10) to corresponding mobile device (30). Means is provided in mobile device application to display product information and product location contained in local matching product database (14). Preferably matching algorithm is automatically activated upon receipt of new mobile device GPS coordinates or upon entry of new products in seller/buyer product database. Preferably products contained in the local matching product database are displayed in order of their proximity to the mobile device. Means to display products in order of proximity to a communication device according to the GPS coordinates corresponding to product location in well known in the art; and does not merit detail description here. Additionally, products contained in local matching product database can also be displayed according to other hierarchical determinants such as price, product relevancy, date of posting of products etc. The invention enables mobile device to be on the look out for products matching requests in mobile client product database in proximity to mobile device location at pre determined intervals; and notify mobile client of product finding on corresponding mobile device when a matching product is found within pre determined distance of mobile device. Once a product request is entered into mobile client database; the second application automatically attempts to find a matching product in the seller product database based on current location of mobile device at predetermined intervals/events; without requiring mobile client input into mobile client product database each time said search application is activated. Multiple search sessions are performed by second application based on varied mobile device locations based on product request saved in mobile client product database from prior data input by mobile client.

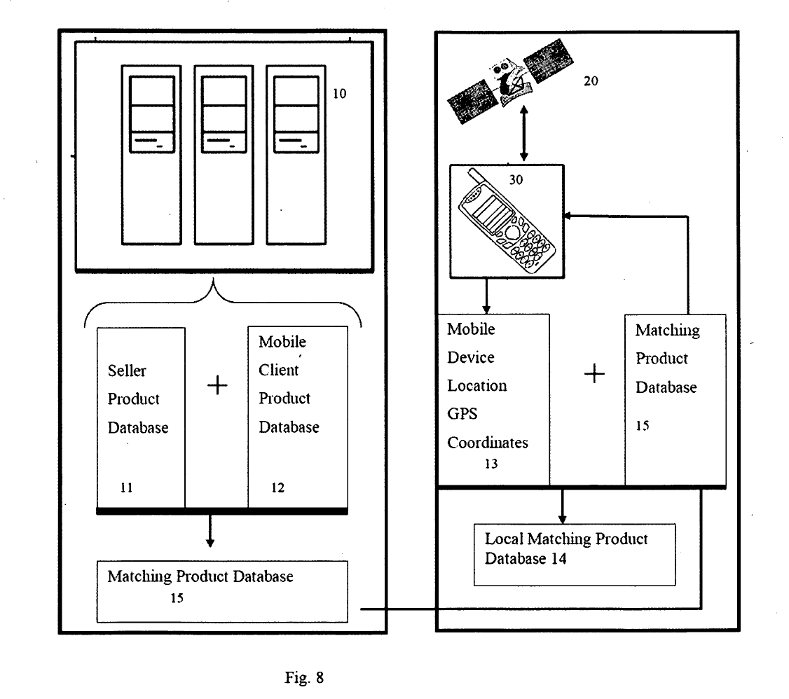

According to another method, shown in FIG. 8, mobile client product database (12) is provided in central server (10). Means is provided for mobile client to enter product request information into mobile client product database (12), preferably via web interface using fixed location devices such as personal computer or using mobile devices. Seller product database (11) is provided in central server (10) with means for seller to enter product information preferably via web interface using fixed location devices such as personal computer or using mobile device. Second application is provided in central server comprising of artificial intelligent matching algorithm having means to match mobile client product database (12) with seller product database (11); and generate a matching product database (15). Further, central server application is programmed to transmit matching product database (15) to mobile device corresponding to mobile client. A first application in mobile device (30) having means to receive satellite (20) position from the GPS system (GPS component module) is provided. GPS component module is preferably programmed to obtain satellite position (20) at pre determined intervals; or alternatively upon user initiation, or continuously while mobile device is powered on. Another aspect of second application is provided in mobile device comprising of artificial intelligent matching algorithm having means to match mobile device location GPS coordinates with product location GPS coordinates of products contained in matching product database (15); and generate a local matching product database (14). Local matching product database (14) contains products in matching product database (15) that are in proximity to current location of mobile device (30). Means is provided in mobile device application to alert mobile client of products contained in local matching product database (14). An advantage of this method is that mobile device (30) does not need to be in communication with central server (10) every time mobile device location GPS coordinates (13) is updated. Preferably, matching product database (15) is uploaded from central server (10) into mobile device (30) at pre determined times or at pre determined events. Preferably matching algorithm is automatically activated upon receipt of new mobile device GPS coordinates or upon entry of new products in seller/buyer product database. Preferably products contained in the local matching product database are displayed in order of their proximity to the mobile device. Means to display products in order of proximity to a communication device according to the GPS coordinates corresponding to product location in well known in the art; and does not merit detail description here. Additionally, products contained in local matching product database can also be displayed according to other hierarchical determinants such as price, product relevancy, date of posting etc. The invention enables mobile device to be on the look out for products matching requests in mobile client product database in proximity to mobile device location at pre determined intervals /events; and notify mobile client of product finding on corresponding mobile device when a matching product is found within pre determined distance of mobile device. Once a product request is entered into mobile client database; either via web interface from mobile device, or fixed location devices such as personal computer; the second application automatically attempts to find a matching product in the seller product database based on current location of mobile device at predetermined intervals; without requiring mobile client input into mobile client product database each time said search application is activated. Multiple search sessions are performed by second application based on varied mobile device locations based on product request saved in mobile client product database from prior data input by mobile client.

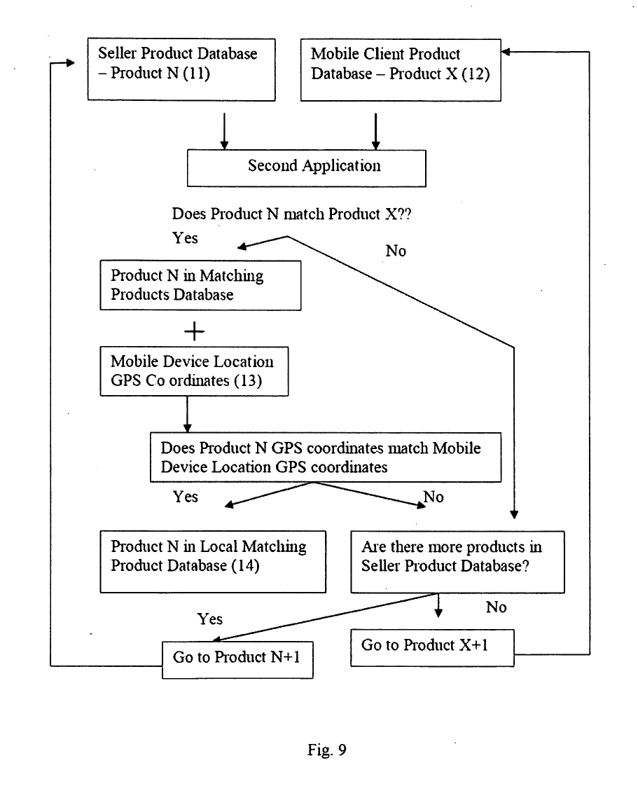

FIG. 9 shows a schematic representation of second application comprising of artificial intelligent matching algorithm having means to match seller product database (11) with mobile client product database (12) to generate matching products database; and thereafter match mobile device location GPS coordinates (13) with product location GPS coordinates in matching products database; and generate local matching products database (14). Preferably matching algorithm is automatically activated upon receipt of new mobile device GPS coordinates or upon entry of new products in seller/buyer product database. According to yet another aspect of the invention; if no matching product is found in response to mobile client product search request; the second application comprising of artificial intelligent matching algorithm is programmed to re-run at a pre determined future time when the seller/buyer product database contains new entry. The second application can be programmed to run after lapse of a pre determined time interval or can be programmed to run after an instance of new product entry into seller/buyer product database.

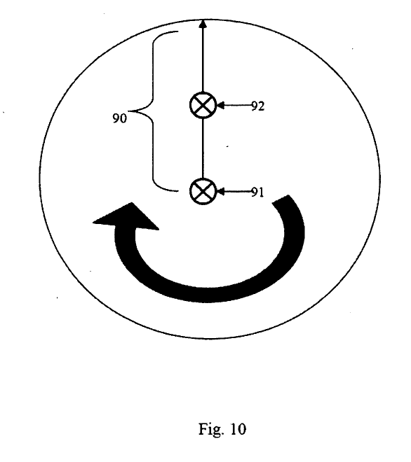

Preferably, mobile client is given option to determine acceptable range of geographic location to confine product search within a desired distance from mobile device location. According to one method shown in FIG. 10, acceptable geographic range is an area covering twice the distance between two consecutive locations of mobile device in 30 minute period (91, 92). This enables product location within 30 minutes of mobile device location in all directions (90). Preferably, mobile client is provided means to customize acceptable geographic range for product location according to user preference. Further, mobile device application preferably has a secondary storage in order to keep information about received maps, product, subscription and other additional information. The mobile device application preferably has additional mechanisms like power managing (activate/deactivate GPS and communications modules), use of ciphered communication etc. In all embodiments of the invention where local matching products database is transmitted from the central server to mobile device; a web link responsive to one or more products contained in the local matching products database can be transmitted to mobile device from central server. Said web link when activated by mobile client; retrieves corresponding product information from central server; where after product information is displayed on mobile device.

According to yet another aspect of the invention, display means, method and apparatus is provided in mobile device to display product information and contact information of corresponding seller.

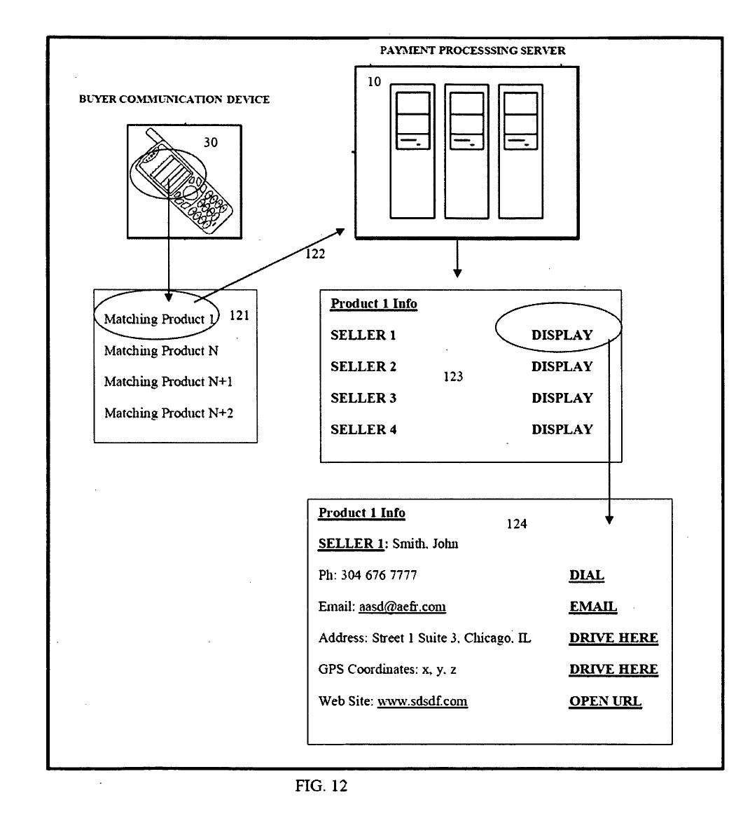

According to a first display method of seller contact information, as shown in FIGS. 12 products list of the local matching product database is displayed (121) on the display means of mobile device. Mobile client is given an option to select a product from the display list (121); at which time set fee is assessed to mobile client's account (122). There after product information and contact information of corresponding sellers is displayed (123, 124) on display means of mobile device (30). Preferably seller contact information is displayed in order of proximity to mobile communication device (123), although other hierarchical algorithms, such as price, date of posting etc. may be used. Preferably mobile client is provided means to speed dial and/or email seller using speed dial/email client of mobile device (124). Additionally, mobile client is provided means to obtain driving directions to the product location (124) from current location or any other location by means of GPS. According to the first display method, mobile device (30) is in communication link with matching application containing a payment processing application. Mobile client account is linked to mobile client payment information: and mobile client account is debited with incurred fee.

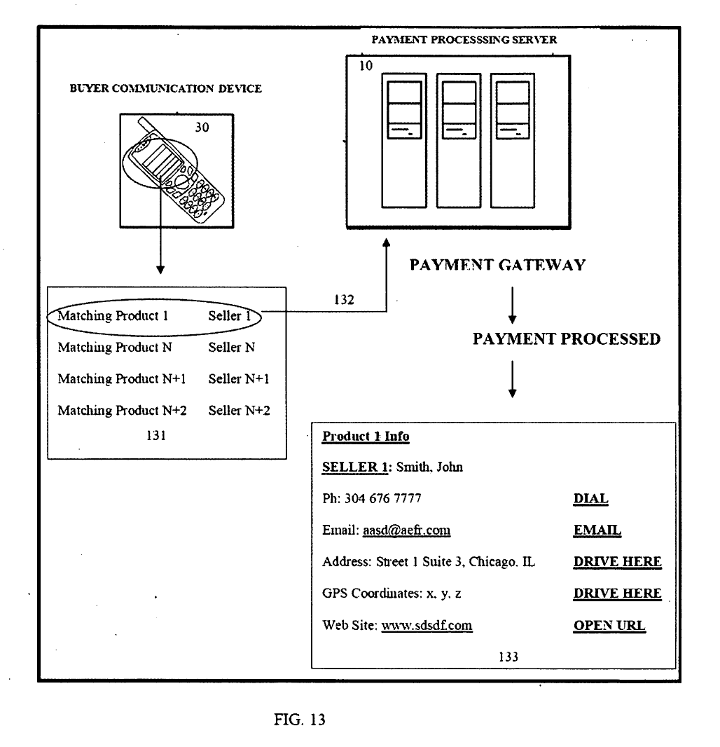

According to a second display method of seller contact information, as shown in FIG. 13, products contained in the local matching product database and corresponding brief seller information are displayed (131) on display means of mobile device (30). Preferably products in the local matching database are displayed in order of proximity to mobile communication device, although other hierarchical algorithms, such as price, date of posting etc. may be used. Mobile client is given an option to select a product and request detail seller contact information (133); at which time a fee is assessed (132) to mobile client. According to the second display method, mobile client account is linked to mobile client payment information; and a payment processing application is provided in the matching application to charge mobile client account the incurred fee. Once required fee is assessed to mobile client account; information contained in user selected data fields (or all data fields) of seller contact information is displayed (133). Preferably mobile client is provided means to speed dial/email seller directly from mobile device (133). Preferably, mobile client is provided means to obtain driving directions to seller location (133).

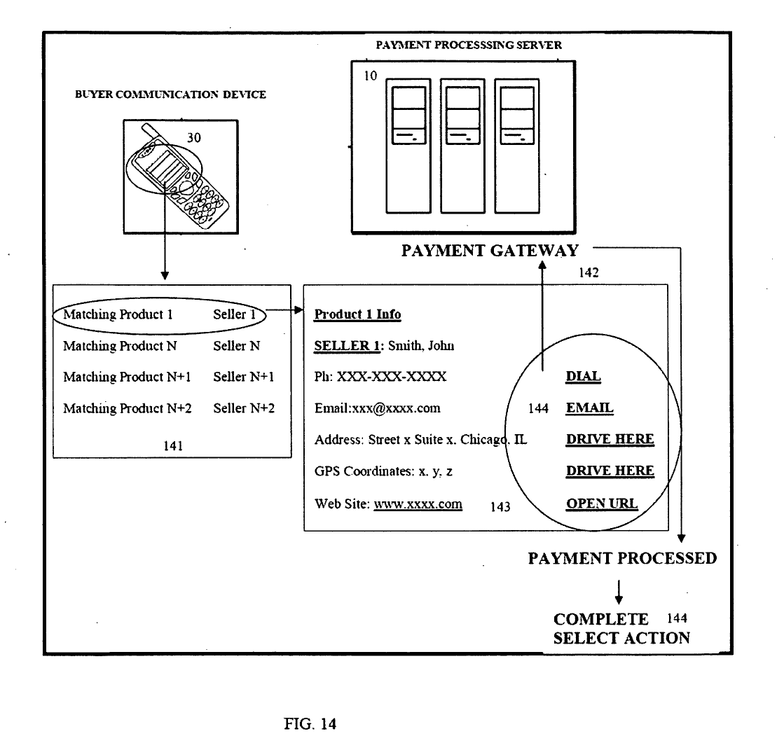

According to a third display method of seller contact information, as shown in FIG. 14, mobile client is prompted to select a product from display list of local matching products database (141); at which time product information and detail seller contact information is displayed (143) on display means of mobile device. Mobile client is prompted to contact seller using speed dial/email client functionality of mobile device (144); at which time a fee for connecting mobile client to seller is assessed (142). According to the third display method, mobile client account is linked to mobile client payment information; and payment processing application is provided in the matching application to charge mobile client the incurred fee. Once required fee is assessed to mobile client account; speed dial/email functionality or any other chosen communication functionality of mobile device application is activated (145). Preferably, mobile client is also provided means to obtain driving directions to seller location (144) from current location or any other location by means of GPS. In the preferred third method, phone number, email address and URL of seller is displayed; however phone number, email address and web site URL, or any other part of detail seller contact information may be encrypted and displayed only upon payment of a fee.

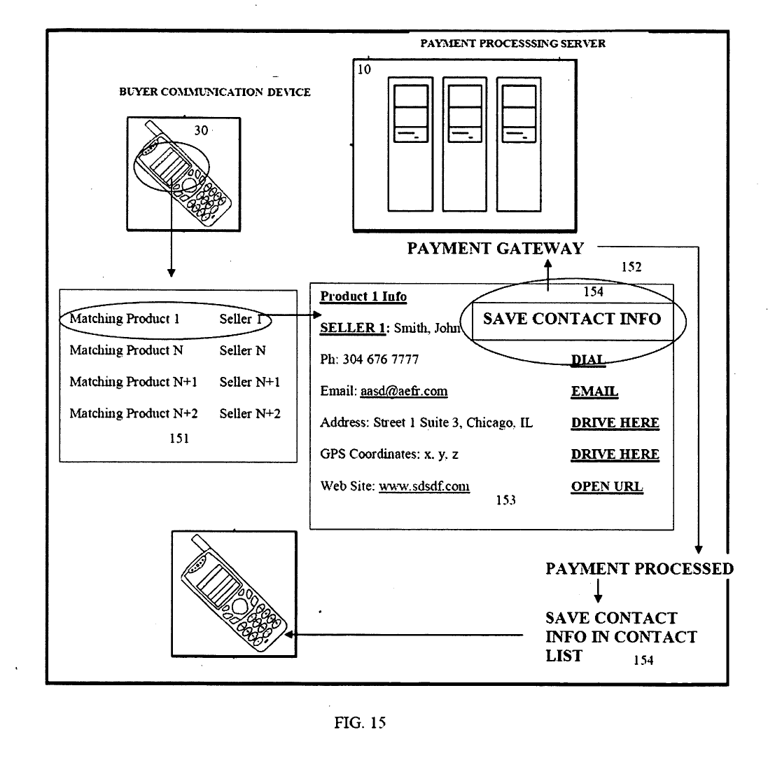

According to a fourth display method of seller contact information, as shown in FIG. 15, mobile client is given an option to select a product from display list of local matching product database (151); at which time product information and detail seller contact information is displayed (153) on display means of mobile device (30). Mobile client is given an option to contact seller using speed dial/email client functionality or any other communication functionality of mobile device (153). Additionally mobile client is prompted to save displayed seller contact information into contact list of mobile device (154); at which time a fee is assessed (152). According to the fourth display method, mobile client account is linked to mobile client payment information; and a payment processing application is provided in the matching application to charge mobile client the incurred fee. Once required fee is assessed to mobile client account; seller contact information is saved into contact list of mobile device communication device (155). Preferably, mobile client is provided means to obtain driving directions to seller location (153) from current location or any other location by means of GPS. Alternatively, the option to save seller contact information into mobile device contact list can be provided to mobile client on a complimentary basis.

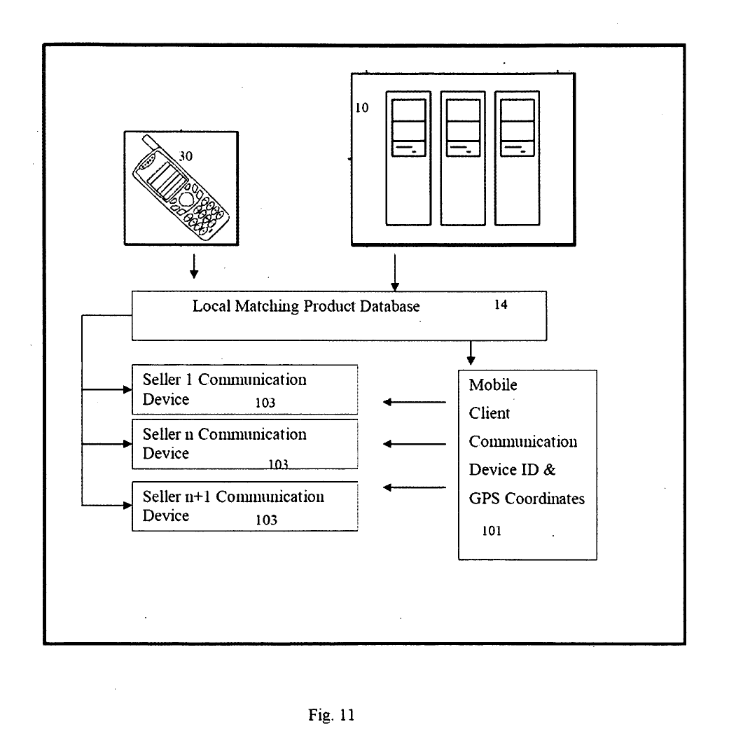

According to another aspect of the invention, as shown in FIG. 11, means is provided to notify one or more sellers; of mobile clients in proximity of seller location; looking for products contained in corresponding seller's account in seller product database contained either in central server (10) or in mobile device (30). Communication link is provided between central server application (10) and mobile device application (30) and seller communication device (103). As mentioned in various methods, systems and apparatus of the invention disclosed in prior paragraphs, artificial intelligent matching algorithm is provided in second application contained in central server (10) or mobile device (30) to generate a local matching product database (14) based on proximity of products contained in seller product database (11) to current mobile device location. Additionally, means is provided in second application contained in central server or mobile device to determine communication device ID (103) of sellers corresponding to products contained in local matching product database (14); arid thereafter transmit contact information (101) of corresponding mobile client to seller communication device (103). Seller communication device can be one or more of personal computer, phone, fax, pager, PDA, and mobile communication device such as mobile phones. Communication of mobile client contact information to seller communication device may be in one or more of email, SMS, voice message, or any other suitable formats. Pursuant to the above; and according to yet another aspect of the invention, display means, method and apparatus is provided in seller communication device to display mobile client (buyer) contact information.

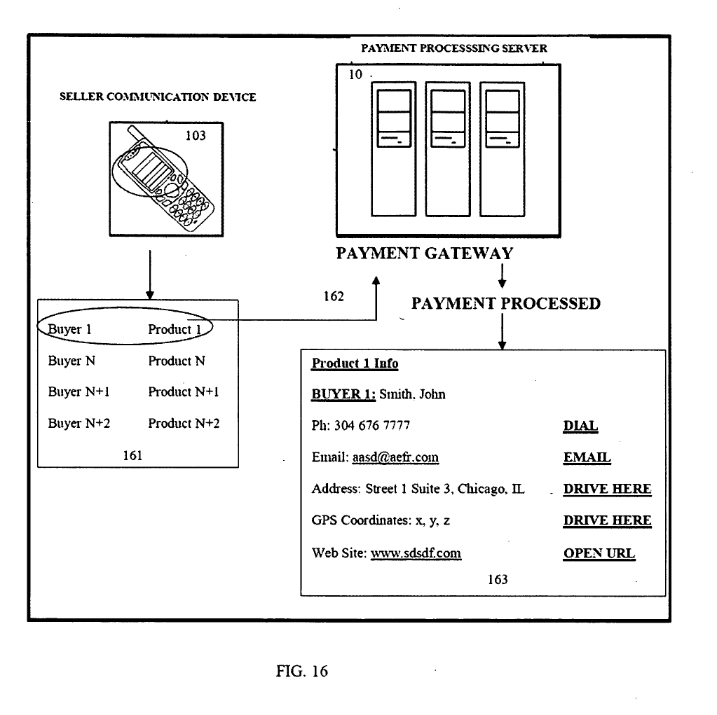

According to a first display method of mobile client (buyer) contact information, as shown in FIG. 16, brief mobile client contact information and corresponding seller product contained in local matching product database of mobile client (161) is displayed on seller communication device (103). Brief mobile client contact information preferably includes at least mobile client name (161). Seller is prompted to request detail mobile client contact information (163) or request information contained in select data fields of mobile client contact information; at which time a fee is assessed to seller's account (162). Preferably seller is provided means to contact mobile client using speed dial/email client functionality or any other communication functionality of communication device (163). Additionally means is provided in seller communication device to obtain driving directions to buyer location (163) from current location or any other location by means of GPS. It is to be noted that multiple mobile client contact information (161) may be displayed on seller communication device if multiple buyers for one or more of seller's products are present within defined range of seller communication device. According to the first display method, seller's account in central server (10) is linked to seller payment information and a payment processing application is provided in the matching application whereby seller's account is debited with incurred fee. Preferably, mobile client information is displayed in order of proximity of mobile client to seller communication device (103). Means to display contact information in order of proximity to a communication device according to the GPS coordinates of contact information is well known in the art; and does not merit detail description here. Additionally, mobile client contact information can alternatively be displayed according to other hierarchical determinants, such as mobile client income, ranking, feedback etc.

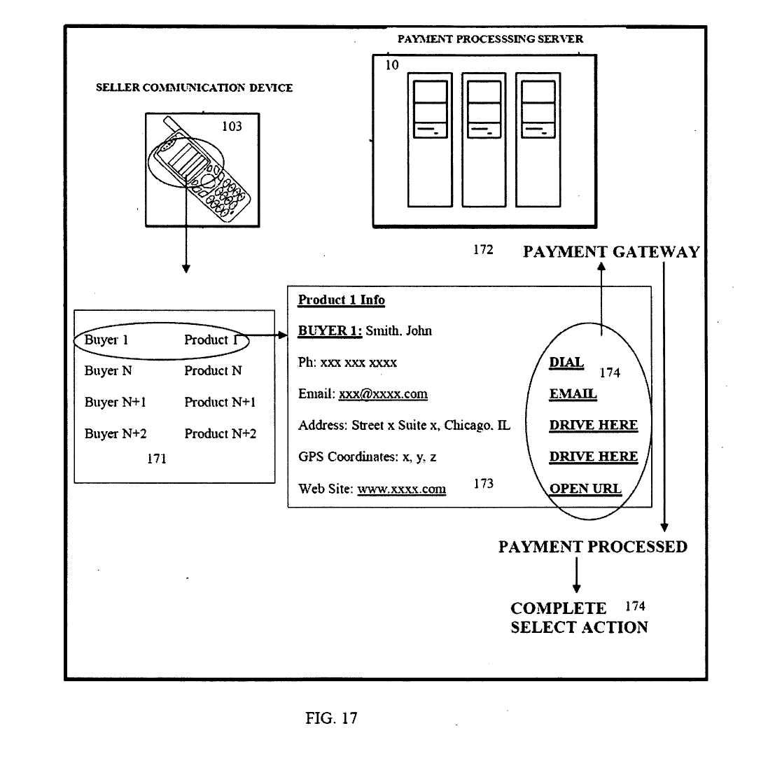

According to a second display method of mobile client (buyer) contact information, as shown in FIG. 17 brief mobile client contact information and corresponding seller product contained in local matching product database of mobile clients is displayed on seller communication device (171). Brief mobile client contact information preferably includes at least mobile client name (171). Seller is prompted to request detail mobile client contact information or request information contained in select data fields of mobile client contact information; at which time detail mobile client contact information is displayed (173). Seller is prompted to use communication features of mobile device; such as speed dial and/or email client; at which time a fee is assessed (172) to connect seller to mobile client. Additionally means is provided in seller communication device to obtain driving directions to buyer location (173) from current location or any other location by means of GPS. It is to be noted that multiple mobile client contact information (171) may be displayed on seller communication device if multiple buyers for one or more of seller's products are present within defined range of seller communication device. According to the second display method, seller's account in central server (10) is linked to seller payment information and a payment processing application is provided in matching application whereby seller's account is charged with incurred fee. Preferably, mobile client information is displayed in order of proximity of mobile client to seller communication device. Means to display contact information in order of proximity to a communication device according to the GPS coordinates of contact information is well known in the art; and does not merit detail description here. Additionally, mobile client contact information can alternatively be displayed according to other hierarchical determinants, such as mobile client income, ranking, feedback etc. In the preferred second method, phone number, email address and URL of mobile client is displayed; however phone number, email address and web site URL, or any other part of the seller contact information may be encrypted and displayed only upon payment of a fee.

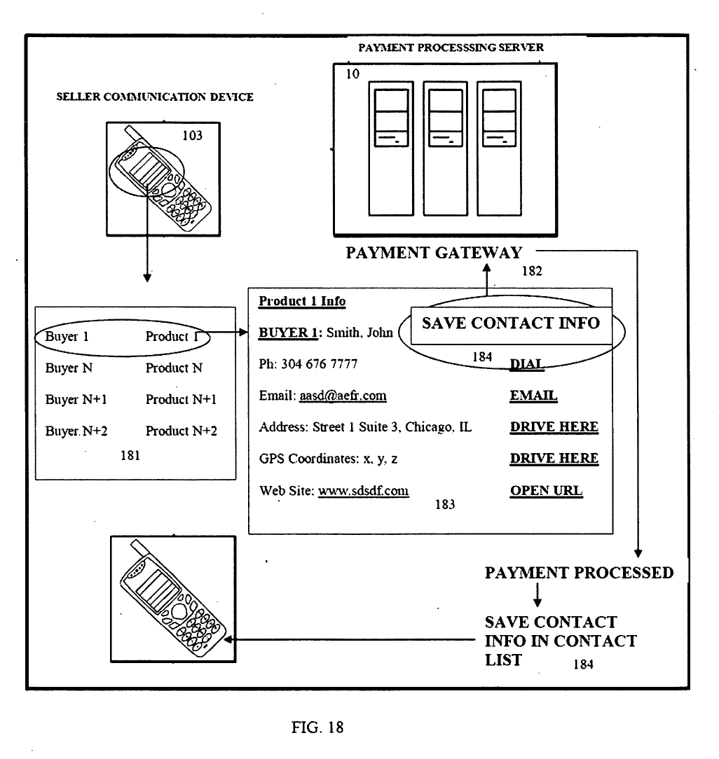

According to a third display method of mobile client (buyer) contact information, as shown in FIG. 18, brief mobile client contact information and corresponding seller product contained in local matching products database of mobile clients (181) is displayed on seller communication device (103). Brief mobile client contact information preferably includes at least mobile client name (181). It is to be noted that multiple mobile client contact information (181) may be displayed on seller communication device if multiple buyers for one or more of seller's products are present within defined range of seller communication device (103). Seller is prompted to request detail mobile client contact information; at which time detail mobile client contact information is displayed (183). Preferably seller is provided means to use communications features of mobile device; such as speed dial and/or email mobile client using speed dial/email client /features of communication device (183). Additionally means is provided in seller communication device to obtain driving directions to buyer location (183) from current location or any other location by means of GPS. Seller is prompted to save detail seller contact information (183) into contact list of seller communication device at which time a fee is assessed to seller (182). Upon payment of required fee, mobile client contact information is saved into contact list of seller communication device (185). According to the third display method, seller's account in central server (10) is linked to seller payment information and a payment processor whereby seller's account is charged with incurred fee. Preferably, mobile client information is displayed in order of proximity of mobile client to seller communication device. Means to display contact information in order of proximity to a communication device according to the GPS coordinates of contact information is well known in the art; and does not merit detail description here. Additionally, mobile client contact information can also be displayed according to other hierarchical determinants, such as mobile client income, ranking, feedback etc. Alternatively, the option to save seller contact information into seller communication device contact list is provided to seller on a complimentary basis.

I claim:

1. A method of display of contact information on communication device comprising; 1) communication device having display means; 2) displaying contact information on communication device; 3) limiting one or more contact information functionality; and 4) activating one or more of contact information functionality upon payment of a fee.

2. The method of claim 1; wherein contact information includes one or more of name, physical address, phone number, fax number, web site URL, email address, and GPS coordinates.

3. The method of claim 1 wherein contact information is retrieved locally from communication device.

4. The method of claim 1; wherein contact information is transmitted from web server.

5. The method of claim 1; wherein contact information functionality includes one or more of speed dialing of displayed phone number, displaying information contained in one or more select data fields of contact information, activating URL links associated with contact information, activating email client, obtaining driving directions to the displayed contact information, and saving displayed contact information into contact list of communication device.

6. The method of claim 1; wherein contact information is stored locally in the communication device.

7. A method of display of contact information comprising; 1) first product database containing seller information, seller product information, and product location; 2) second product database containing buyer product request and buyer information; 3) first application in mobile device having means to determine mobile device location at pre determined intervals or events and having means to communicate mobile device location to second application; 4) second application having means to match first and second product databases; and mobile device location at pre determined intervals or events to generate local matching products database; 5) second application having means to determine buyer contact information; and having communication link with seller communication device; 6) second application communicating buyer information to seller communication device corresponding to products contained in local matching products database; 7) displaying buyer contact information in seller communication device; 8) limiting one more contact information functionality; and 9) activating one or more contact information functionality upon payment of fee.

8. The method of claim 7; wherein contact information is in one or more of text, voice, image, and video formats and comprises of one or more of mobile client name, physical address, phone number, fax number, web site URL, email address, and GPS coordinates.

9. The method of claim 7 wherein mobile device location is determined by one or more of GPS co-ordinates, cellular tower triangulation, and access point location; and product location is determined by one or more of GPS co ordinates, postal code, and physical address.

10. The method of claim 7; wherein second application is hosted in one or more of mobile communication device or web server.

11. The method of claim 7; wherein displayed contact information is retrieved locally from communication device, or is transmitted to communication device from web server.

12. The method of claim 7; wherein contact information functionality includes one or more of speed dialing of displayed phone number, displaying information contained in one or more select data fields of contact information, activating URL links associated with contact information, activating email client, obtaining driving directions to the displayed contact information, saving displayed contact information into contact list of communication device, and displaying complete contact information of corresponding entity.

13. A method of display of contact information comprising; 1) first product database containing seller product information and product location; 2) second product database containing buyer product request; 3) first application in mobile device having means to determine mobile device location and having means to communicate mobile device location to second application at predetermined events or intervals; 4) second application having means to match first and second product databases; and mobile device location at pre determined intervals to generate local matching products database; 5) mobile device having display means for products contained in location based matching product database; 6) displaying seller contact information; 7) limiting one or more contact information functionality; and 8) activating one or more of contact information functionality upon payment of fee.

14. The method of claim 13; wherein product information is in one or more of text, voice, image, and video formats.

15. The-method of claim 13; wherein mobile device location is determined by one or more of GPS co-ordinates, cellular tower triangulation, and access point location.

16. The method of claim 13; wherein product location is determined by one or more of GPS co ordinates, postal code, and physical address.

17. The method of claim 13; wherein contact information functionality includes one or more of speed dialing of displayed phone number, activating URL links associated with contact information, activating email client, obtaining driving directions to the displayed contact information, saving displayed contact information into contact list of communication device, and displaying information contained in select or all data fields of contact information.

18. The method of finding sellers of claim 13 wherein contact information is in one or more of text, voice, image, or video formats.

19. The method of finding sellers of claim 13; wherein contact information comprises of one or more of seller name, physical address, phone number, fax number, web site URL, email address, and GPS coordinates.

20. The method of claim 13; wherein displayed contact information is retrieved locally from communication device, or is transmitted to communication device from web server.
